(19) United States
(12) Patent Application Publication
(10) Pub. No.: US 2024/0378288 A1
(43) Pub. Date: Nov. 14, 2024

(54) ANOMALOUS ACTIVITY MITIGATION

(71) Applicant: BRITISH TELECOMMUNICATIONS PUBLIC LIMITED COMPANY, London, Greater London (GB)

(72) Inventors: Tazar HUSSAIN, London, Greater London (GB); Alfie BEARD, London, Greater London (GB)

(21) Appl. No.: 18/690,166

(22) PCT Filed: Sep. 2, 2022
(86) PCT No.: PCT/EP2022/074526

§ 371 Date: Mar. 7, 2024

(30) Foreign Application Priority Data
Sep. 8, 2021 (GB) 2112756.8

(51) Int. Cl. G06F 21/55

(52) U.S. Cl. CPC G06F 21/554; G06F 2221/034

(57) ABSTRACT

A computer-implemented method comprising: obtaining activity data indicative of an anomalous activity within a computer system; processing the activity data to generate confidence data representative of a set of confidence values, each confidence value representative of a confidence that the anomalous activity comprises a respective type of activity; and determining, based on at least the confidence data, mitigating action to take to mitigate the anomalous activity. Further examples relate to a computer system configured to implement an intrusion detection system and an intrusion response system, and to a computer-implemented method of calibrating a system comprising a machine learning model trained to generate output uncalibrated confidence data representative of a set of output uncalibrated confidence values.

### TECHNICAL FIELD

The present invention relates to mitigation of an anomalous activity within a computer system.

### BACKGROUND

Intrusion Detection Systems (IDSs) monitor activity within computer systems, such as network activity, and detect intrusions or other hostile activities. One of the key challenges for security analysts is in managing the large number of false positive alerts generated by IDSs. Current IDSs also struggle to identify attacks in any detail. In addition, a huge number of Internet of Things (IoT) sensors and actuators are added to the Internet every day and due to their limited resources, in terms of battery and processing power, these devices are more vulnerable to malware and other attacks than traditional systems. There is hence an increasing opportunity for malicious parties to carry out cyber-attacks. Traditional methods of identifying intrusions cannot cope with the ever increasing number and scale of attack attempts.

An Intrusion Response System (IRS) can then be used to deploy countermeasures and stop malicious activities identified by an IDS, such as blocking an Internet Protocol (IP) address, updating a firewall rule or generating an alert. A goal of an IRS is to select an optimal response to an attack, which is a response which halts an intrusion with minimal adverse effect on the computer system under attack. In order to meet this goal, a deep understanding of attack patterns, attack behaviour and the correlation between different types of attacks is required, which is challenging to achieve. If an IRS is not appropriately configured, the IRS may deploy inappropriate actions in response to attacks. This can compromise the security of the computer system, which in turn can adversely affect the performance of the computer system and/or a network to which the computer system is connected, and reduce the ability of a user to perform desired tasks using the computer system or network.

It is an aim of the present invention to at least alleviate some of the aforementioned problems.

### SUMMARY

According to a first aspect of the present disclosure, there is provided a computer-implemented method comprising: obtaining activity data indicative of an anomalous activity within a computer system; processing the activity data to generate confidence data representative of a set of confidence values, each confidence value representative of a confidence that the anomalous activity comprises a respective type of activity; and determining, based on at least the confidence data, mitigating action to take to mitigate the anomalous activity.

In some examples, processing the activity data comprises processing the activity data using a machine learning (ML) model trained to generate output confidence data representative of a set of output confidence values in response to processing input activity data indicative of an input anomalous activity within at least one of: the computer system and a further computer system, each output confidence value representative of a confidence that the input anomalous activity comprises a respective type of activity. The ML model may comprise a random forest model. In some of these examples, the confidence data is calibrated confidence data, the set of confidence values is a set of calibrated confidence values, processing the activity data using the ML model comprises processing the activity data using the ML model to generate initial confidence data representative of a set of initial confidence values, and processing the activity data further comprises calibrating the set of initial confidence values to generate the set of calibrated confidence values. Calibrating the set of initial confidence values may comprise obtaining the set of calibrated confidence values from the set of initial confidence values by processing the set of initial confidence values using a non-parametric calibration function. The non-parametric calibration function may be an isotonic function. The ML model may be a calibrated ML model.

In some examples, determining the mitigating action to take comprises determining the mitigating action to take based on a comparison between at least one of the set of confidence values and a threshold value. In some of these examples, the threshold value is a first threshold value and determining the mitigating action to take comprises: determining to take a first mitigating action in response to determining that a confidence value of the set of confidence values exceeds the first threshold value; and determining to take a second mitigating action, different from the first mitigating action, in response to determining that the confidence value is between a second threshold value and the first threshold value, wherein the second threshold value is lower than the first threshold value.

In some examples, the set of confidence values comprises: a first confidence value representative of a first confidence that the anomalous activity comprises a first type of activity; and a second confidence value representative of a second confidence that the anomalous activity comprises a second type of activity, different from the first type of activity; and determining the mitigating action to take comprises determining the mitigating action to take based on a comparison between the first confidence value and the second confidence value.

In some examples, the method comprises: computing, based on at least one of: a confidence value of the set of confidence values, a severity of the anomalous activity, and a criticality of the computer system to operation of a telecommunications network comprising the computersystem, a risk metric indicative of a risk to the telecommunications network of the anomalous activity; and determining to take the mitigating action based on the risk metric.

In some examples, the activity data represents at least one intrusion detection alert.

In some examples, the types of activity represented by the set of confidence values comprise at least one malicious activity and at least one benign activity.

According to a second aspect of the present disclosure, there is provided a computer-implemented method of calibrating a system comprising a machine learning (ML) model trained to generate output uncalibrated confidence data representative of a set of output uncalibrated confidence values in response to processing input activity data indicative of an input anomalous activity within a computer system, each output uncalibrated confidence value representative of an uncalibrated confidence that the input anomalous activity comprises a respective type of activity, the method comprising: processing, using the ML model, calibration activity data representative of an anomalous activity within at least one of: the computer system and a further computer system, to generate uncalibrated confidence data representative of a set of uncalibrated confidence values, each uncalibrated confidence value representative of an uncalibrated confidence that the anomalous activity comprises a respective type of activity; computing an uncertainty metric associated with the set of uncalibrated confidence values; and adjusting parameters associated with the ML model, based on the uncertainty metric, to calibrate the ML model, thereby generating a calibrated ML model.

In some examples, the uncertainty metric is indicative of a dissimilarity between at least one of the set of uncalibrated confidence values and a corresponding at least one of a set of ground truth confidence values.

In some examples, adjusting the parameters associated with the ML model comprises adjusting the parameters associated with the ML model to reduce the uncertainty metric.

In some examples, the system comprises a non-parametric calibration model, and the method comprises: processing the calibration activity data using the calibrated ML model to generate initial confidence data representative of a set of initial confidence values; and adjusting the non-parametric calibration model to fit a non-parametric calibration function represented by the non-parametric calibration model to the set of initial confidence values, wherein the non-parametric calibration function is useable to obtain the set of calibrated confidence values from the initial confidence values. Fitting the non-parametric calibration function may comprise fitting the non-parametric calibration function using isotonic regression.

According to a third aspect of the present disclosure, there is provided computer-readable medium storing thereon a program for carrying out the method of any examples in accordance with the first or second aspects of the present disclosure.

According to a fourth aspect of the present disclosure, there is provided a computer system configured to implement: an intrusion detection system (IDS) to: obtain activity data indicative of an anomalous activity within at least one of: the computer system and a further computer system; and process the activity data to generate confidence data representative of a set of confidence values, each confidence value representative of a confidence that the anomalous activity comprises a respective type of activity; and an intrusion response system (IRS) to: obtain the confidence data from the intrusion detection system; and determine, based on at least the confidence data, mitigating action to take to mitigate the anomalous activity.

In some examples, to process the activity data, the IDS is configured to process the activity data using a machine learning (ML) model trained to generate output confidence data representative of a set of output confidence values in response to processing input activity data indicative of an input anomalous activity within at least one of: the computer system and a further computer system, each output confidence value representative of a confidence that the input anomalous activity comprises a respective type of activity. In some of these examples, the confidence data is calibrated confidence data, the set of confidence values is a set of calibrated confidence values, and, to process the activity data, the IDS is configured to process the activity data using the ML model to generate initial confidence data representative of a set of initial confidence values, and processing the activity data further comprises calibrating the set of initial confidence values to generate the set of calibrated confidence values. To calibrate the set of initial confidence values, the IDS may be configured to obtain the set of calibrated confidence values from the set of initial confidence values by processing the set of calibrated confidence values using a non-parametric calibration function.

According to a fifth aspect of the present disclosure, there is provided a telecommunications network comprising the computer system of any examples in accordance with the fourth aspect of the present disclosure.

### BRIEF DESCRIPTION OF THE DRAWINGS

For a better understanding of the present disclosure, reference will now be made by way of example only to the accompany drawings, in which:

FIG. 1 is a flow diagram of a method of determining mitigating action to take to mitigate an anomalous activity within a computer system according to examples;

FIG. 2 is a schematic diagram of a computer system according to examples;

FIG. 3 shows schematically a method of determining mitigating action to take to mitigate an anomalous activity within a computer system according to further examples;

FIG. 4 is a table of calibrated confidence values associated with respective activity types predicted using the method of FIG. 3;

FIG. 5 is a table of mitigating actions determined to be taken, based on the calibrated confidence values of FIG. 4;

FIG. 6 is a flow diagram of a method of calibrating a system to generate calibrated confidence data according to examples; and

FIG. 7 is a schematic diagram of internal components of a system according to examples.

### DETAILED DESCRIPTION

Apparatus and methods in accordance with the present disclosure are described herein with reference to particular examples. The invention is not, however, limited to such examples.

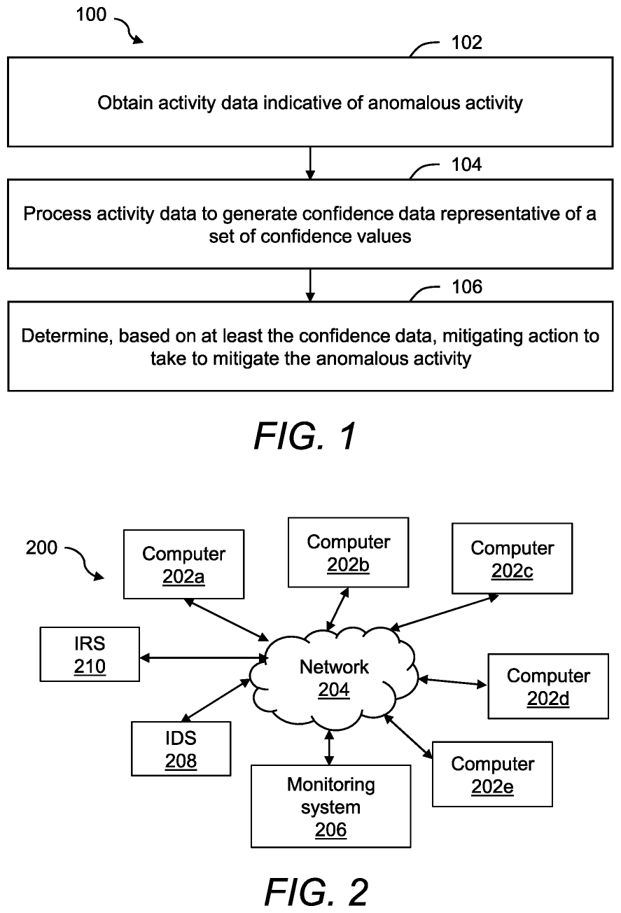

FIG. 1 is a flow diagram of a method 100 of determining mitigating action to take to mitigate an anomalous activity within a computer system according to examples. In FIG. 1, the method 100 is computer-implemented. In other words, it is performed by a computer system, which includes one or more computers.

At item 102 of the method 100, activity data indicative of an anomalous activity within the computer system is obtained. The activity data is for example received from an IDS, and may represent at least one intrusion detection alert, which are generated by the IDS when the anomalous activity is detected. The IDS may be a conventional IDS, which generates a log file including a series of entries, each corresponding to a respective intrusion detection alert. The anomalous activity within the computer system is for example anomalous activity performed by the computer system or in which the computer system participates. For example, the anomalous activity may include the computer system sending or receiving anomalous network traffic via a network to which the computer system is connected.

Activity is for example considered anomalous if it deviates from normal, expected or otherwise usual activity within the computer system, e.g. if it deviates by a significant or appreciable amount. However, the origin of anomalous activity may be benign in nature. For example, if an authorised user begins to use a workplace computer system in a new way, e.g. due to a change in their job role, the activity performed by the computer system may suddenly change, which may be identified as anomalous. However, in this case, the anomalous activity corresponds to legitimate activities of an authorised user, and does not represent a security threat. In other cases, though, anomalous activity may be malicious in nature, such as activity performed by an unauthorised party as part of a cyber-attack or in preparation for a cyber-attack. It is hence important to identify the nature of the anomalous activity so appropriate action can be deployed (if necessary).

Activity within the computer system may, in some cases, be incorrectly identified as anomalous. For example, an IDS may generate a false positive alert. A false positive alert example indicates that particular activity within the computer system has been identified as anomalous, whereas, in actuality, the activity is not anomalous. To account for this, item 104 of the method 100 involves processing the activity data to generate confidence data representative of a set of confidence values. Each confidence value is representative of a confidence that the anomalous activity comprises a respective type of activity. In this way, a probability distribution is used to represent the activity predictions, so as to quantify the uncertainty in these predictions. In other words, rather than merely relying identifying the type of activity the activity data is most likely to represent, the method 100 provides a more nuanced insight into the confidence associated with this prediction. For example, if the highest confidence value of the set of confidence values is not much larger than the second highest confidence value, this may indicate that the uncertainty associated with a prediction that the activity is of the type corresponding to the highest confidence value is relatively high. Conversely, if the highest confidence value is significantly larger than the second highest confidence value, this may indicate that the uncertainty associated with the prediction that the activity is of the type corresponding to the highest confidence value is relatively low.

At item 106 of the method 100, mitigating action to take to mitigate the anomalous activity is determined based on at least the confidence data. By taking the confidence data into account in determining the mitigating action, more appropriate mitigating action can be identified and taken, which can improve the security of the computer system. For example, the mitigating action can be determined based on a relative value of at least one of the set of confidence values compared to at least one other one of the set of confidence values. As an example, if the highest confidence value is not much larger than the second highest confidence value, more cautious mitigating action can be taken (which is e.g. less disruptive to the functioning of the computer system) than if the highest confidence value is significantly larger than the second highest confidence value. The less cautious mitigating action taken if the highest confidence value is significantly larger than the second highest confidence value may be more combative mitigating action, which is likely to be more effective in mitigating the anomalous activity but at the cost of disrupting the functioning of the computer system (which may nevertheless be justified in order to prevent a debilitating cyber-attack). Determining the mitigating action to be taken can include determining how to prioritise the mitigating action based on the confidence data, e.g. so that mitigating actions for an anomalous activity identified as corresponding a particularly disruptive type of activity with a relatively high confidence value can be prioritised compared to activity with a lower confidence value for being of that type of activity and/or with a similarly high confidence value but for a less disruptive type of activity. Furthermore, this approach can reduce the deployment of mitigation action for false positive alerts identified by an IDS. For example, if these false positive alerts are identified as having a relatively low confidence value for being of particular (e.g. malicious) types of activity, it may be determined that no mitigating action is needed.

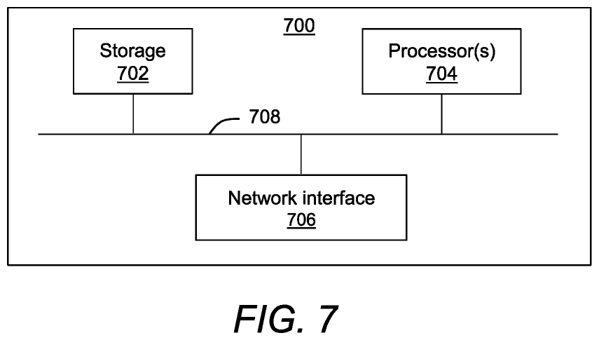

FIG. 2 is a schematic diagram showing an example computer system 200 for use with the examples herein. The computer system 200 includes a plurality of computers 202a-202e. It is to be appreciated, though, that a computer system in other examples may correspond to a single computer. Each of the computers 202a-202e may be similar to the computer 700 described further below with reference to FIG. 7, and may be a single computing device or a distributed computer.

The computers 202a-202e are each connected to a network 204 in FIG. 2. In this way, the computers 202a-202e can communicate with each via the network 204, which is for example a telecommunications network. The network 204 may be a single network or may comprise a plurality of networks. The network 204 may be or include a wide area network (WAN), a local area network (LAN) and/or the Internet, and may be a personal or enterprise network.

The computer system 200 exhibits various activity as the computers 202a-202e are used. In the example of FIG. 2, the activity of the computer system 200 includes network activity within the network 204. The activity of the computer system 200 may be represented as events that have occurred within the computer system 200, each corresponding to the performance of a particular task or activity. In such cases, events may correspond to log entries of log files of a monitoring system or other security system for monitoring computer behaviour, e.g. sensor activations and/or network activity. Activity of a computer system may represent at least one incident (e.g. corresponding to at least one event), which may be indicative of an attempted attack.

In the example of FIG. 2, a monitoring system 206, which is arranged to monitor network events within the network 204, generates behaviour data, which in this case is representative of such events. Any suitable monitoring system 206 may be used. In one case, the monitoring system 206 includes a network tap (terminal access point), which is a device configured to analyse network traffic. A network tap typically has at least three ports: an A port, a B port and a monitor port. A tap between the A and B ports transfers data received to the desired destination, while also copying the data to the monitor port. In another case, the monitoring system 206 includes a device (such as a router or switch) configured to implement the NetFlow protocol to collect network traffic as it enters or exits the device. The network data represents or is otherwise based on the network traffic in these cases.

In the example 200 of FIG. 2, the monitoring system 206 sends the behaviour data to an intrusion detection system (IDS) 208 of the computer system 200 via the network 204. The IDS 208 stores the behaviour data and processes the behaviour data to identify an anomalous activity of the computer system 200, thereby generating activity data indicative of the anomalous activity. The skilled person will appreciate that there are various techniques for intrusion detection, any of which may be utilised by the IDS 208. The IDS 208 in this case is a further computer, which may be similar to or the same as any of the computers 202a-202e connected to the network 204. The IDS 208 processes the activity data to generate the confidence data, for example as described above with reference to item 104 of FIG. 1.

After obtaining the confidence data, the IDS 208 in this example sends the confidence data to an intrusion response system (IRS) 220, via the network 204. The IRS 220 then determines mitigating action to take to mitigate the anomalous activity, based on at least the confidence data, for example as described above with reference to item 106 of FIG. 1. After determining the mitigating action to take, the IRS 220 in this case controls the performance of the mitigating action, for example by performing the mitigating action itself or by instructing at least one actuator to perform the mitigating action. In other examples, though, the performance of the mitigating action may be controlled by another component of the computer system 200 or a further computer system.

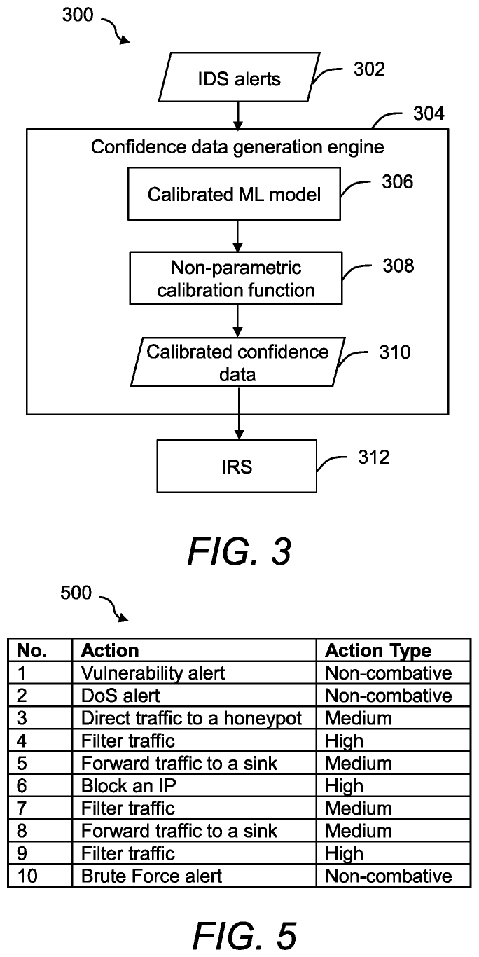

FIG. 3 shows schematically a method 300 of determining mitigating action to take to mitigate an anomalous activity within a computer system according to further examples. The method 300 of FIG. 3 is an example implementation of the method 100 of FIG. 1, and involves receiving activity data, which in this example represents IDS alerts 302 (which may be referred to as intrusion detection alerts). The IDS alerts 302 are sent to a confidence data generation engine 304 for processing to generate confidence data, which in this case is calibrated confidence data. Prior to sending the IDS alerts 302 to the confidence data generation engine 304, the IDS alerts 302 may undergo pre-processing and/or feature selection. Pre-processing can be used to remove or enhance information included in the data to be processed to generate the confidence data, and/or to convert a format of the data (in this case, the activity data representing the IDS alerts) so it is suitable or more straightforward to process to generate the confidence data. Feature selection can be used to reduce the number of features represented by the activity data, so as to reduce the computational cost in generating the confidence data.

In this example, the IDS alerts 302 are in the form of text files (e.g. CSV, comma-separated values, files), representing an anomalous activity (e.g. an attempted cyber-attack), each with a list of features and corresponding values, from which raw data representing the activity within the computer system is extracted. The IDS alerts 302 include socket information such as source and destination IP (Internet Protocol) addresses (e.g. each in the form: X1.X2.X3.X4, where X1-X4 each represent a number, which may be the same as or different from each other) and source and destination port numbers. Pre-processing of the IDS alerts 302 is performed to remove the socket information to avoid overfitting. The pre-processing also involves applying a cleaning process to the IDS alerts 302, so as to remove feature labels with white spaces and to remove missing or erroneous values (such as infinity values). The IDS alerts 302 in this case originally include activity names in a string format, which is incompatible with certain methods of generating confidence data. Pre-processing in this case hence involves converting activity name labels from strings to a numerical format.

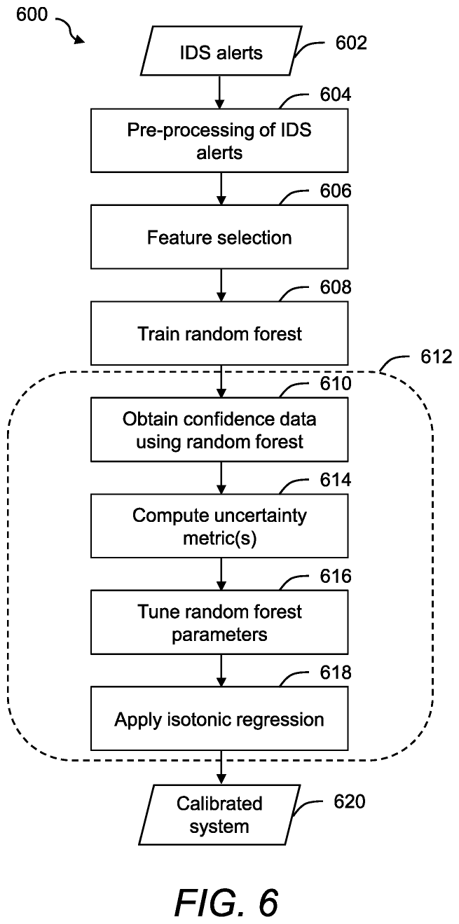

In the example of FIG. 3, each IDS alert 302 represents 84 flow-based features, obtained using NetFlow, such as one or more of: the source IP address, the destination IP address, the flow packets, the flow duration and the flow bytes. Feature selection is performed to select a subset of these features, to improve the efficiency with which the confidence generation is performed. In this example, the confidence data generation engine 304 is configured to implement a calibrated machine learning (ML) model 306, which in this case is a calibrated random forest (RF) model, although other calibrated ML models are possible in other examples. An example of obtaining a calibrated ML model is described below, with reference to FIG. 6. The built-in feature importance of an RF model can be used to select the features, e.g. to select n most important features. Selection of the features can be performed for example by training an RF model using a first set of features (e.g. all 84 features in this case), calculating the Gini importance of each of the features and measuring how effective each feature is in reducing the uncertainty for each tree in the forest. The n most important features can then be selected based on this analysis. In this example, the 53 most important features are selected, but this is merely an example. The selected features can then be used to re-train the RF model, which can then be calibrated as discussed further below with reference to FIG. 6.

After pre-processing and feature selection, the activity data (which in this case represents the pre-processed and feature-selected IDS alerts 302) is processed by the calibrated ML model 306. Hence, in this example, the selected 53 features represented by the activity data are processed using the calibrated ML model 306 (rather than processing the 84 features prior to the feature selection). The calibrated ML model 306 is trained to generate output confidence data representative of a set of output confidence values in response to processing input activity data indicative of an input anomalous activity (e.g. within the computer system from which the IDS alerts 302 were obtained or from a further computer system. Each output confidence value is representative of a confidence that the input anomalous activity comprises a respective type of activity. In this example, the calibrated ML model 306 is a calibrated RF model, which is ensemble-based, and uses a bagging technique to combine different models and fit each on different subsets of the activity data.

The calibrated ML model 306 is hence trained to output a confidence value distribution for the types of activity, rather than a single output of e.g. the most likely type of activity represented by the activity data. For example, the confidence values may represent probability values. As explained above, this improves the determination of a suitable mitigating action to be taken to mitigate the anomalous activity represented by the activity data.

The example of FIG. 3 involves a two-step process to further refine the set of confidence values. In FIG. 3, the output produced by the calibrated ML model 306, which may be considered to be initial confidence data representative of a set of initial confidence values, is calibrated to generate a set of calibrated confidence values, which are used to determine the mitigating action to take. Calibration of a set of initial confidence values for example involves adjusting at least one of the set of initial confidence values to more accurately capture the true probability that the activity data represents each different type of activity. Distorted confidence values can lead to the deployment of inappropriate actions, if used to determine which actions to take. For example, if a denial of service (DoS) attack is predicted with a confidence value (e.g. a probability) of 0.4, whereas the true probability is 0.8, then a less effective action, such as “monitor traffic” instead of “filter traffic” may be deployed, which can adversely affect the performance of the computer system. Calibration can be used to reduce the distortion in confidence values. In this example, the calibration itself involves two steps: the activity data is first processed by a ML model, which is itself a calibrated ML model 306, which has undergone a calibration process. The initial confidence data is then further calibrated by processing the set of initial confidence values using a non-parametric calibration function 308. In other examples, though, the ML model used to process the activity data need not be a calibrated ML model, although this may reduce the accuracy of the initial confidence data obtained.

Processing the set of initial confidence values using the non-parametric calibration function 308 for example obtains a smoother set of calibrated confidence values, which are less likely to suffer from outliers that may not accurately reflect the confidence in particular predictions. In the example of FIG. 3, the non-parametric calibration is an isotonic function, which is a non-decreasing function that captures variations in the underlying set of initial confidence values in a smoother manner than relying on the set of initial confidence values themselves. The isotonic function can be obtained during calibration of the confidence data generation engine 304 (which e.g. may form part of a training phase, for training the confidence data generation engine 304, rather than a test phase). For example, isotonic regression can be used to fit the isotonic function to outputs of the calibrated ML model 306, as discussed further with reference to FIG. 6. The isotonic function after fitting can then be deployed as the non-parametric calibration function 308 at test time. The non-parametric calibration function 308 converts an input confidence value (e.g. one of the set of initial confidence values) to a calibrated confidence value. Hence, by processing the set of initial confidence values using the non-parametric calibration function 308, a corresponding set of calibrated confidence values can be obtained, which in FIG. 3 are represented by calibrated confidence data 310.

The calibrated confidence data 310 is then sent to an IRS 312, which determines, based on at least the calibrated confidence data 310, mitigating action to be taken in response to the anomalous activity represented by the IDS alerts 302. It is to be appreciated that the types of activity represented by the set of confidence values (including the set of calibrated or initial confidence values) may include at least one malicious activity and at least one benign activity. This can further facilitate the distinguishing of benign activities from malicious activities based on the associated confidence values, allowing more appropriate mitigating action to be determined.

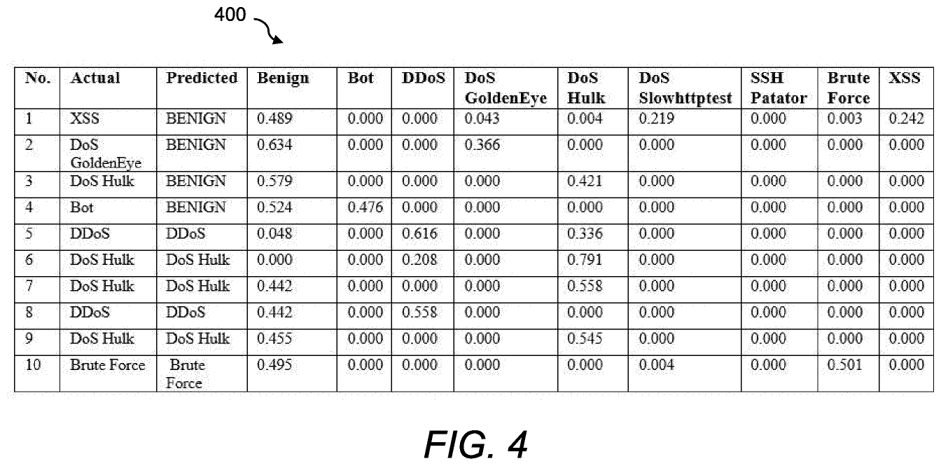

The mitigating action can be determined in various ways, based on confidence data (in this case, based on the calibrated confidence data 310), as will be explained further with reference to FIGS. 4 and 5. FIG. 4 is a table 400 of calibrated confidence values associated with respective activity types predicted using the method of FIG. 3. The table 400 of FIG. 4 shows the calibrated confidence values for ten different sets of activity data. In this example, the types of activity for which a calibrated confidence value is determined are: benign activity, a bot attack, a distributed denial of service attack (DDoS), a DoS Goldeneye attack, a DoS Hulk attack, a DoS Slowhttptest attack, a secure shell (SSH) Patator attack, a brute force attack, and a cross site scripting (XSS) attack, although this is merely an example. The table 400, which is for illustration only, includes the actual type of activity represented by the activity data for each of the ten sets of activity, as well as the predicted type of activity, predicted based on the calibrated confidence values. In use, though, the actual type of activity is typically not available.

In this example, an attack is predicted to be of the type with the highest confidence value (which in this example is a calibrated confidence value). The table 400 indicates that although the types of various attacks have been predicted correctly, for some of these attacks there is a non-zero confidence value that these attacks actually correspond to benign activity. For example, the first four attacks have been misclassified as corresponding to benign activity. However, as can be seen from the confidence values themselves, the method 300 has obtained a confidence value for the correct attack type which is lower than that of benign activity, but which is still higher than the confidence value for other (non-benign) activities. For example, for the first attack, a XSS attack was predicted to be benign activity, but the method 300 provides greater insight by calculating the confidence values across various activities (in this case, calculating a confidence value of 0.489 that the first attack is benign and a 0.242 confidence value that the first attack is an XSS attack). This allows a more nuanced analysis of the activity to be performed, which can in turn allow more appropriate mitigating actions to be determined and deployed.

The remainder of the table 400 indicates that attacks 5 to 10 have been predicted correctly by the method 300. Nevertheless, for some of these attacks, there is a non-zero confidence value that the activity is actually of a different type than the predicted type (albeit with a lower confidence value than that for the predicted type). This can be seen from attack 5, in which the confidence value that attack 5 is a DDoS attack is 0.616, and the confidence value that attack 5 is another type of DDoS attack (a DoS Hulk attack) is 0.336. In contrast, for attack 6, the confidence values that attack 6 is a Dos Hulk and DDoS attack are 0.791 and 0.208, respectively.

The confidence values in the table 400 of FIG. 4 are used by the IRS 312 of FIG. 3 to determine suitable mitigating action for activity within the computing system. Mitigating action is for example action that prevents or stops activity (e.g. an activity) or lessens the impact of that activity. An action can be classified as combative if it impacts the performance of the computing system or a network of the computing system in one way or another. Examples of combative actions include: blocking IP addresses or ports. Non-combative actions are actions that do not appreciably impact the computing system or network performance, such as generating alerts or collecting logs. The IRS 312 appropriately evaluates the activity identified and the costs of the activity (e.g. such as the negative impact of allowing the activity to continue), based on the confidence data (which in this case is calibrated confidence data), so as to determine appropriate mitigating action. For example, the IRS 312 can determine whether to take combative or non-combative action to mitigate particular activity.

In some examples, determining the mitigating action to take comprises determining the mitigating action to take based on a comparison between at least one of the set of confidence values and a threshold value. The comparison may be performed between the highest of the set of confidence values (which e.g. may be taken as indicative of the most likely type of the activity) and the threshold value. The threshold value may be set by a security analyst, for example, depending on a desired security level for the computer system. For example, if the highest confidence value is greater than 0.8, it may be determined to take a combative action, such as blocking an IP address. If, however, the highest confidence value is less than or equal to 0.8, a less combative or non-combative action may be taken. This approach ensures that more combative actions are taken if the confidence values exceed the threshold value, so as to avoid deploying combative actions (which impact on the performance of the computer system or network) in cases in which the predicted type of activity may be incorrect (indicated by a lower confidence value).

In one case, it is determined to take a first mitigating action in response to determining that a confidence value of the set of confidence values (e.g. a highest confidence value) exceeds a first threshold value. If, however, the confidence value is between a second, lower, threshold value and the first threshold value, it is determined to take a second, different mitigating action. In one examples, if the type of activity with the highest confidence value is a DDoS, the IRS 312 determines to halt the activity if the confidence value is greater than or equal to 0.6 and less than 0.8. However, if the confidence value is greater than or equal to 0.8, the IRS 312 determines to shut down the computer system. Halting the activity is a less combative action than shutting down the computer system. Hence, this is an example of using a threshold mechanism to deploy an effective mitigating action.

In examples such as this, the method 300 employed by the IRS 312 may involve seeking confirmation from a further system or actor, such as a human in the loop (HITL), e.g. a security analyst that the determined mitigating action should be deployed. The mitigating action may then be deployed in response to receiving confirmation from the further system or actor. Whether further confirmation such as this is sought may depend on at least one of the confidence values, such as the highest confidence value, and/or on the nature of the mitigating action determined to be taken. For example, in the example above, confirmation of whether to halt the activity is sought if the confidence value is greater than or equal to 0.6 and less than 0.8. However, the computer system is shut down automatically, without further intervention, if the confidence value is greater than or equal to 0.8, as this confidence value is considered to indicate high certainty that the type of activity (and the appropriate mitigating action) has been correctly identified.

In some examples, confidence data, which may be calibrated confidence data, is combined with domain knowledge to further improve the reliability in determining an appropriate mitigating action. Domain knowledge in intrusion detection and response is the additional information regarding the type of attack, the severity of the attack, the importance of the targeted computer system, the cost of taking mitigating action to mitigate the attack and so forth. This information can be used as part of a risk assessment process. Performing such a risk assessment process can involve identifying the value of the computer system (e.g. a criticality of the computer system to operation of a telecommunications network), a severity of the anomalous activity (e.g. the potential damage caused by the activity, the vulnerabilities associated with the computer system etc.) and the likelihood that the anomalous activity has been correctly identified (e.g. represented by at least one of the confidence values, such as the highest confidence value). A risk metric indicative of a risk, e.g. a risk to the telecommunications network, of the anomalous activity can be computed based on at least one of a confidence value of the set of confidence values, the severity of the anomalous activity and the criticality of the computer system to operation of the telecommunications network. In one example, the risk metric is calculated as:

$$R = C V * S * C R$$

where R represents the risk metric, CV represents an event reliability, which is e.g. the likelihood that the anomalous activity has been correctly identified and can be calculated as the highest confidence value mapped to a range between 0 and 10, S represents the severity of the attack in a range from 0 to 5, and CR represents the criticality of the computer system in a range from 0 to 5 (which may be considered to correspond to an asset value of the computer system. In this example, if the risk metric is in the range from 0 to 10, the mitigating action is taken (where the type of mitigating action to be taken can be determined as described above, and/or based on expert knowledge e.g. of a security analyst). The values for CR and S can be set by an expert such as a security analyst. This approach can make intrusion response more systematic, by tightly coupling the nature of the attack and the importance of the computer system with the mitigating action to be taken.

It is to be appreciated that the confidence values, e.g. generated using the methods 200, 300 of FIG. 2 or 3, themselves can find further utility in interpreting and understanding activity within the computer system that has been analysed, such as activity that has been incorrectly classified. In table 400 of FIG. 4, the first four attacks have been misclassified as being benign activity. This indicates that the behaviour associated with attacks of these types have a close resemblance with benign activity. Moreover, as each of these attacks has a non-zero confidence value for an attack (as well as having a higher confidence value for being benign) it could be inferred that these confidence values indicate that an attack is in progress but incomplete or that the activity has been misclassified as benign. Analysis of prior confidence values and mitigating actions taken and e.g. whether the mitigating actions successfully mitigated identified activity can be used to refine rules (e.g. thresholds) for future usage of the method 300.

In some examples, the mitigating action is determined based on a comparison between a first confidence value representative of a first confidence that the anomalous activity comprises a first type of activity and a second confidence value representative of a second confidence that the anomalous activity comprises a second type of activity, different from the first type of activity. This can further improve the determination of an appropriate mitigating action. For example, if the first type of activity is a malicious activity and the second type of activity is a benign activity, and the second confidence value is higher than the first confidence value but by an amount which is less than a threshold amount, this may indicate that a determination that the activity is benign could be incorrect. This situation may occur for example if the malicious activity is in progress but has not yet been completed, in which case the malicious activity may have certain features in common with benign activity. In such cases, it may be determined to take mitigating action to mitigate the first type of activity (which in this case is malicious) to reduce the risk of an adverse effect to the computer system if the anomalous activity is allowed to continue. Conversely, if the second confidence value is higher than the first confidence value by an amount that meets or exceeds a threshold amount, it may be determined that the anomalous activity is likely to be benign and hence that no mitigating action (or a different type of mitigating action) is needed to address the benign activity occurring in the computer system.

The mitigating action may be determined based solely on such a comparison and/or a combination of such a comparison and at least one other factor, such as a comparison between the first and/or second confidence values and at least one threshold. For example, with reference to the example in which the first type of activity is malicious and the second type of activity is benign, it may be determined to take particular mitigating action to mitigate the malicious (first) type of activity if the second confidence value is higher than the first confidence value but by an amount which is less than a threshold amount and if the first confidence value itself exceeds a threshold value. With this approach, it can be determined to perform particular mitigating action if there is sufficient confidence that the activity is likely to be of a particular type (addressable by the particular mitigating action). Mitigating action can hence be taken in these cases, without taking mitigating action (or taking less combative mitigating action) if there is a lower certainty that the activity is of a particular type (which may be the case e.g. if each of the confidence values is relatively similar to each other, but with a relatively small magnitude).

FIG. 5 is a table 500 of the mitigating actions the IRS 312 of FIG. 3 determines are to be taken in response to the 10 activities shown in the table 400 of FIG. 4. These mitigating actions are based on the confidence values in the table 400 of FIG. 4. As can be seen, the table 500 includes a range of different actions that can be taken. These actions include actions of high and medium combativeness, as well as non-combative actions. In this example, although the first four activities are predicted to be benign, the IRS 312 nevertheless determines to deploy mitigating action to mitigate these activities (given the relatively high confidence values associated with other, non-benign, types of activity for each of these first four activities). By deploying the mitigating actions, activity misclassified as benign can nevertheless be mitigated, and attacks at an early stage (which may appear to be benign) can also be appropriately mitigated.

In this example, activities 1, 2 and 10 are assigned non-combative actions (the generation of a vulnerability alert, a DoS alert and a brute force alert), as the highest confidence values for a non-benign type of activity for each of activities 1, 2 and 10 is relatively low (but still not insignificant relative to the confidence values for benign activity). In the case of activity 3, the medium level action “traffic was directed to a honeypot” is assigned as the highest confidence value for a non-benign type of activity (DoS Hulk) of 0.421 is relatively high (greater than 0.4). A “Filter traffic” action is recommended for activity 4, as the highest confidence value for a non-benign type of activity (bot attack) of 0.476 is relatively high and the severity of a bot attack is high. This action is comparatively more combative (and is categorised as being of high combativeness) even though the confidence value for the activity to be a bot attack is not that high (0.476), due to the severity of a bot attack. In the case of activities 5 and 8, the highest confidence values are 0.616 and 0.558 respectively, which are medium values, and consequently an action of medium combativeness of forwarding traffic to a sink is suggested. The block IP action is a highly combative action, but it has been suggested to counter DoS attacks with very high confidence (e.g., for activity 6, with a confidence value associated with a DoS attack, in this case a DoS Hulk attack, of 0.791). DoS Hulk attacks for activities 7 and 9 are predicted with medium confidence values, therefore an action of medium combativeness, namely “filter traffic”, has been determined by the IRS 312 to mitigate these activities.

As explained above, the mitigating actions can be further based on domain knowledge, and can be verified by security analysts or deployed automatically. By taking the confidence values into consideration in determining the mitigating action to take, and e.g. whether the mitigating action is combative or non-combative, cost sensitive and rational action deployment is achieved.

FIG. 6 is a flow diagram of a method 600 of calibrating a system to generate calibrated confidence data according to examples. The method 600 of FIG. 6 can, for example, be used to obtain a confidence data generation engine such as the confidence data generation engine 304 of FIG. 3, which is an example of a system after having undergone calibration. The method 600 includes receiving calibration activity data representative of an anomalous activity within a computer system, for calibrating the system, which in this case is in the form of IDS alerts 602 (which may be similar to the IDS alerts 302 described with reference to FIG. 3). A suitable dataset for calibrating the system is for example the CICIDS2017 dataset, which is a flow based IDS alert dataset generated by the Canadian Institute of Cybersecurity in 2017, as described in “Toward Generating a New Intrusion Detection Dataset and Intrusion Traffic Characterization”, Sharafaldin et. al., published in the Proceedings of the 4^{th} International Conference on Information Systems Security and Privacy—ICISSP, pp. 108-116, 2018. The IDS alerts in the CICIDS2017 dataset have been captured in a realistic environment with a variety of activities, which can be divided into five broad categories: seven types of DoS attack, three types of password-based attack, one type of scanning attack, four types of vulnerability attacks and benign activity, which accounts for more than 80% of the activity within this dataset. A network traffic flow generator and analyser, such as the CICFlowerMeter-V3 is used to extract 84 flow-based flow features from the dataset (e.g. as described above with reference to FIG. 3) for each record (e.g. corresponding to a particular activity) from Packet Capture (PCAP) files representing the records. The features extracted include the source and destination IP addresses and port numbers.

The IDS alerts 602 undergo pre-processing 604 and feature selection 606, which again may be similar to the pre-processing and feature selection described above with reference to FIG. 3. In this example, the pre-processing also includes splitting the IDS alerts 602 into training and testing datasets, e.g. so that the 80% of the IDS alerts 602 are allocated to the training dataset and 20% of the IDS alerts 602 are allocated to the testing dataset, which can be used to validate the training.

At item 608, the IDS alerts, after pre-processing and feature selection, are used to train an ML model, which in this example is a RF model. In this case, 53 features are selected and used to train the RF model. In this example, default parameters are used for the training, except for the class weights, which is set to balanced, to adjust for the fact that the highly imbalanced class distribution of attacks and benign activity in the training dataset. In this way, the RF model is trained to generate output uncalibrated confidence data representative of a set of output uncalibrated confidence values in response to processing input activity data indicative of an input anomalous activity within a computer system. Each output uncalibrated confidence value is representative of an uncalibrated confidence that the input anomalous activity comprises a respective type of activity.

At item 610, the testing data of the IDS alerts, after the pre-processing and feature selection, are then processed using the trained RF model, to generate uncalibrated confidence data representative of a set of uncalibrated confidence values. Each uncalibrated confidence value is representative of an uncalibrated confidence that the anomalous activity comprises a respective type of activity. In this case, a built-in function associated with the trained RF model (model.predict_proba(X_test)) is used to obtain the uncalibrated confidence data, but this is merely an example. The uncalibrated confidence data is obtained as part of a calibration process 612, in which the uncalibrated confidence values are adjusted to more accurately represent the actual confidence values, so as to obtain a set of calibrated confidence values, which can be used to determine mitigating action to take into response to an anomalous activity within a given computer system.

In the example method 600 of FIG. 6, the calibration process 612 includes, at item 614, computing an uncertainty metric associated with the set of uncalibrated confidence values obtained by the processing the testing data using the trained RF model at item 610. One or more of various uncertainty metrics may be computed to capture an uncertainty associated with the predicted uncalibrated confidence values. In some cases, the uncertainty metric is indicative of a dissimilarity between at least one of the set of uncalibrated confidence values and a corresponding at least one of a set of ground truth confidence values.

Suitable uncertainty metrics include a Brier Score (BS), a Log Loss (LL) and an Expected Calibration Error (ECE). The Brier Score corresponds to the mean squared error between predicted uncalibrated confidence values and the ground truth confidence values. For multiclass classification the Brier Score can be computed as:

$$B S = \frac{1}{N} {\sum }_{t = 1}^{N} {\sum }_{i = 1}^{R} {( {f}_{t i} - {o}_{t i} )}^{2} ,$$

where R is the number of classes and N is the total number of instances from all the classes in a multiclass problem. fₜᵢ is the predicted uncalibrated confidence value for a given class (in this case, for a given type of activity) and oₜᵢ represents the ground truth confidence value either as 1 or 0, at an instance t.

The Log Loss is the distance between the uncalibrated and ground truth confidence values and is measured on a logarithmic scale. The Log Loss can then be used to penalise the confidence values. The Log Loss for a single instance (e.g. a single type of activity) is calculated as,

$$- log P ( yt \vert yp ) = - ( yt log ( yp ) + ( 1 - yt ) log ( 1 - yp ) ) :$$

where yt represents the ground truth and yp is the estimated probability when yt is equal to a positive class or class 1.

The ECE is defined as the sum of the absolute value of the differences in accuracy and uncertainty (sometimes referred to as confidence) in each bin. The ECE is designed to measure the alignment between accuracy and uncertainty, and involves partitioning predicted uncalibrated confidence values into M bins and taking the average of the bins:

$$ECE = {\sum }_{m = 1}^{n} \frac{\vert Bm \vert}{n} \vert acc ( {B}_{m} ) - u n c ( {B}_{m} ) \vert ,$$

where n is the number of samples (e.g. the number of activity records in the testing dataset), Bₘ corresponds to the mth bin and the difference between acc (accuracy) and unc (uncertainty) represents the calibration gap.

These uncertainty metrics provide a quantitative way to measure calibration. A better calibration tends to lead to lower BS, LL and ECE. This is exploited at item 616 of the method 600 of FIG. 6, in which the parameters associated with the RF model are adjusted, based on the uncertainty metric (or uncertainty metrics if more than one metric is used), to calibrate the RF model, so as to generate a calibrated ML model. For example, the parameters associated with the RF model can be adjusted to reduce the uncertainty metric or uncertainty metrics. In the example of FIG. 6, this adjustment is performed using the GridSearchCV application programming interface (API), but this is merely an example.

In some cases, the calibration process 612 may cease after item 616. In other words, the parameters may be adjusted to calibrate the ML model (in this case, the RF model), which can then be used to generate confidence data. However, the method 600 of FIG. 6 uses a two-step calibration process 612 to further improve calibration. In FIG. 6, the system undergoing calibration includes a non-parametric calibration model, which represents a non-parametric calibration function. In this case, after the RF model is calibrated, the calibration activity data is processed using the calibrated RF model to generate initial confidence data representative of a set of initial confidence values (e.g. as described above with reference to FIG. 3). The non-parametric calibration model is then adjusted to fit a non-parametric calibration function represented by the non-parametric calibration model to the set of initial confidence values. The non-parametric calibration function can then be used to obtain a set of calibrated confidence values from the initial confidence values, e.g. as described above with reference to items 308 and 310 of FIG. 3.

In the example of FIG. 6, fitting the non-parametric calibration function involves fitting the non-parametric calibration function using isotonic regression. For example, the CalibratedClassifierCV( ) function from the Python® Scikit-learn® Library. Isotonic regression is a non-parametric technique for calibration, and in this case involves fitting a piecewise non-decreasing function to the initial confidence values predicted by the calibrated RF model. For example, an untrained non-parametric calibration model can be passed to the CalibratedClassifierCV( ) API with the default number of folds of five. The API averages the confidence values for each fold of a prediction.

After the fitting of the non-parametric calibration function at item 618, the calibrated system 620 is obtained, which in this case includes the calibrated RF model and the (fitted) non-parametric calibration function. The calibrated system 620 can then be used to obtain a set of calibrated confidence values indicative of a respective calibrated confidence that an anomalous activity includes a respective type of activity. Calibrating the system in this manner improves the confidence and accuracy of the predictions made by the system. In particular, the uncertainty metrics associated with the predictions have been found to decrease by using this calibration process.

FIG. 7 is a schematic diagram of internal components of a system that may be used in the implementation of any of the methods described herein, which in this example is a computer system 700. For example, the computer system 700 may be used as any of the computers 202a-202e, the monitoring system 206, the IDS 208 or the IRS 220 of FIG. 2. The computer system 700 in FIG. 7 is implemented as a single computer device but in other cases a similar computer system may be implemented as a distributed system.

The computer system 700 includes storage 702 which may be or include volatile or non-volatile memory, read-only memory (ROM), or random access memory (RAM). The storage 702 may additionally or alternatively include a storage device, which may be removable from or integrated within the computer system 700. The storage 702 may be referred to as memory, which is to be understood to refer to a single memory or multiple memories operably connected to one another. The storage 702 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The computer system 700 also includes at least one processor 704 which is configured to perform processing, e.g. to implement any of the methods described herein. The at least one processor 704 may be or comprise processor circuitry. The at least one processor 704 is arranged to execute program instructions and process data, such as the network data. The at least one processor 704 is for example arranged to process instructions, obtained from the storage 702, to implement any of the methods described herein. The at least one processor 704 may include a plurality of processing units operably connected to one another, including but not limited to a central processing unit (CPU) and/or a graphics processing unit (GPU).

The computer system 700 further includes a network interface 706 for connecting to a network, such as the network 204 of FIG. 2. A computer system otherwise similar to the computer system 700 of FIG. 7 may additionally include at least one further interface for connecting to at least one further component, such as a display interface for connecting to a display device (which may be separable from or integral with the computer system). The components of the computer system 700 are communicably coupled via a suitable bus 708.

Further examples relate to a computer-readable medium storing thereon instructions which, when executed by a computer, cause the computer to carry out the method of any of the examples described herein.

Yet further examples are envisaged. In the example of FIG. 2, the activity of the computer system 200 includes network activity within the network 204. However, in other cases, the activity of a computer system which is to undergo intrusion detection may be or include different types of activity than network activity. For example, where the computer system includes at least one sensor, activity of the computer system may include a sensor activation of the sensor. Furthermore, in FIG. 2, the computer system 200 in which the anomalous activity occurs includes the IDS 208 and the IRS 210. However, in other examples, an IDS and/or an IRS may form part of a different computer system than a computer system in which at least part of the anomalous activity occurs. In addition, although the IDS 208 and the IRS 210 are shown as being implemented using separate computers in FIG. 2, in other examples a single computer (or a single distributed computer system) may implement the functionality of both the IDS 208 and the IRS 210.

Pre-processing and feature selection are described above with reference to FIG. 3. It is to be appreciated that activity data representing activity in a form other than IDS alerts may similarly undergo pre-processing and/or feature selection. In FIG. 3, IDS alerts 302 are processed by a calibrated ML model 306 and a non-parametric calibration function 308. However, in other examples, activity data (which may represent IDS alerts or activity in a different format) need not be processed by both a calibrated ML model 306 and a non-parametric calibration function 308. For example, the activity data may be processed by just the calibrated ML model 306 to generate the confidence data. In other examples, activity data may be processed by a ML model which is not necessarily a calibrated ML model (such as a conventional RF model) to generate confidence data. In these other examples, the confidence data may then be used to determine mitigating action to take or the confidence data may be calibrated, e.g. by a non-parametric calibration function such as the non-parametric calibration function 308 of FIG. 3, to generate calibrated confidence data for use in determining the mitigating action to take.

Each feature disclosed herein, and (where appropriate) as part of the claims and drawings may be provided independently or in any appropriate combination. Any apparatus feature may also be provided as a corresponding step of a method, and vice versa.

In general, it is noted herein that while the above describes examples, there are several variations and modifications which may be made to the described examples without departing from the scope of the appended claims. One skilled in the art will recognise modifications to the described examples.

Any reference numerals appearing in the claims are for illustration only and shall not limit the scope of the claims. As used throughout, the word ‘or’ can be interpreted in the exclusive and/or inclusive sense, unless otherwise specified.

1. A computer-implemented method comprising:
obtaining activity data indicative of an anomalous activity within a computer system;
processing the activity data to generate confidence data representative of a set of confidence values, each confidence value representative of a confidence that the anomalous activity comprises a respective type of activity; and
determining, based on at least the confidence data, mitigating action to take to mitigate the anomalous activity.

2. The method of claim 1, wherein processing the activity data comprises processing the activity data using a machine learning (ML) model trained to generate output confidence data representative of a set of output confidence values in response to processing input activity data indicative of an input anomalous activity within at least one of: the computer system and a further computer system, each output confidence value representative of a confidence that the input anomalous activity comprises a respective type of activity.

3. The method of claim 2, wherein the ML model comprises a random forest model.

4. The method of claim 2, wherein the confidence data is calibrated confidence data, the set of confidence values is a set of calibrated confidence values, processing the activity data using the ML model comprises processing the activity data using the ML model to generate initial confidence data representative of a set of initial confidence values, and processing the activity data further comprises calibrating the set of initial confidence values to generate the set of calibrated confidence values.

5. The method of claim 4, wherein calibrating the set of initial confidence values comprises obtaining the set of calibrated confidence values from the set of initial confidence values by processing the set of initial confidence values using a non-parametric calibration function.

6. The method of claim 5, wherein the non-parametric calibration function is an isotonic function.

7. The method of claim 2, wherein the ML model is a calibrated ML model.

8. The method of claim 1, wherein determining the mitigating action to take comprises determining the mitigating action to take based on a comparison between at least one of the set of confidence values and a threshold value.

9. The method of claim 8, wherein the threshold value is a first threshold value and determining the mitigating action to take comprises:
determining to take a first mitigating action in response to determining that a confidence value of the set of confidence values exceeds the first threshold value; and
determining to take a second mitigating action, different from the first mitigating action, in response to determining that the confidence value is between a second threshold value and the first threshold value, wherein the second threshold value is lower than the first threshold value.

10. The method of an, claim 1, wherein:
the set of confidence values comprises:
a first confidence value representative of a first confidence that the anomalous activity comprises a first type of activity; and
a second confidence value representative of a second confidence that the anomalous activity comprises a second type of activity, different from the first type of activity; and
determining the mitigating action to take comprises determining the mitigating action to take based on a comparison between the first confidence value and the second confidence value.

11. The method of claim 1, comprising:
computing, based on at least one of: a confidence value of the set of confidence values, a severity of the anomalous activity, and a criticality of the computer system to operation of a telecommunications network comprising the computer system, a risk metric indicative of a risk to the telecommunications network of the anomalous activity; and
determining to take the mitigating action based on the risk metric.

12. The method of claim 1, wherein the activity data represents at least one intrusion detection alert.

13. The method of claim 1, wherein the types of activity represented by the set of confidence values comprise at least one malicious activity and at least one benign activity.

14. A computer-implemented method of calibrating a system comprising a machine learning (ML) model trained to generate output uncalibrated confidence data representative of a set of output uncalibrated confidence values in response to processing input activity data indicative of an input anomalous activity within a computer system, each output uncalibrated confidence value representative of an uncalibrated confidence that the input anomalous activity comprises a respective type of activity, the method comprising:
processing, using the ML model, calibration activity data representative of an anomalous activity within at least one of: the computer system and a further computer system, to generate uncalibrated confidence data representative of a set of uncalibrated confidence values, each uncalibrated confidence value representative of an uncalibrated confidence that the anomalous activity comprises a respective type of activity;
computing an uncertainty metric associated with the set of uncalibrated confidence values; and
adjusting parameters associated with the ML model, based on the uncertainty metric, to calibrate the ML model, thereby generating a calibrated ML model.

15. The method according to claim 14, wherein the uncertainty metric is indicative of a dissimilarity between at least one of the set of uncalibrated confidence values and a corresponding at least one of a set of ground truth confidence values.

16. The method according to claim 14, wherein adjusting the parameters associated with the ML model comprises adjusting the parameters associated with the ML model to reduce the uncertainty metric.

17. The method according to claim 14, wherein the system comprises a non-parametric calibration model, and the method comprises:
processing the calibration activity data using the calibrated ML model to generate initial confidence data representative of a set of initial confidence values; and
adjusting the non-parametric calibration model to fit a non-parametric calibration function represented by the non-parametric calibration model to the set of initial confidence values, wherein the non-parametric calibration function is useable to obtain the set of calibrated confidence values from the initial confidence values.

18. The method according to claim 17, wherein fitting the non-parametric calibration function comprises fitting the non-parametric calibration function using isotonic regression.

19. A computer-readable medium storing thereon a program for carrying out the method of claim 1.

20. A computer system configured to implement:
an intrusion detection system (IDS) to:
obtain activity data indicative of an anomalous activity within at least one of: the computer system and a further computer system; and
process the activity data to generate confidence data representative of a set of confidence values, each confidence value representative of a confidence that the anomalous activity comprises a respective type of activity; and
an intrusion response system (IRS) to:
obtain the confidence data from the intrusion detection system; and
determine, based on at least the confidence data, mitigating action to take to mitigate the anomalous activity.

21. The computer system of claim 20, wherein, to process the activity data, the IDS is configured to process the activity data using a machine learning (ML) model trained to generate output confidence data representative of a set of output confidence values in response to processing input activity data indicative of an input anomalous activity within at least one of: the computer system and a further computer system, each output confidence value representative of a confidence that the input anomalous activity comprises a respective type of activity.

22. The computer system of claim 21, wherein the confidence data is calibrated confidence data, the set of confidence values is a set of calibrated confidence values, and, to process the activity data, the IDS is configured to process the activity data using the ML model to generate initial confidence data representative of a set of initial confidence values, and processing the activity data further comprises calibrating the set of initial confidence values to generate the set of calibrated confidence values.

23. The computer system of claim 22, wherein, to calibrate the set of initial confidence values, the IDS is configured to obtain the set of calibrated confidence values from the set of initial confidence values by processing the set of calibrated confidence values using a non-parametric calibration function.

24. A telecommunications network comprising the computer system of claim 20.
